(19) United States
(12) Patent Application Publication
(10) Pub. No.: US 2005/0228757 A1
(43) Pub. Date: Oct. 13, 2005

(54) Purchase method with price negotiation

(75) Inventors: Fang Cheng Sun, Chungho City (TW); Ching Hua Huang, Chungho City (TW); Hung Cheng Lin, Chungho City (TW)

Correspondence Address: TROXELL LAW OPPICE PLLC;SUITE 1404, 5205 LEESBURG PKE, FALLS CHURCH, VA, 22041, US

(73) Assignee: TREND-GO.COM INC.

(21) Appl. No.: 10/820,741

(22) Filed: Apr. 9, 2004

(51) Int. Cl. G06F 17/60

(52) U.S. Cl. 705/80

(57) ABSTRACT

A purchase method with price negotiation is used for facilitating a real-time purchase transaction in a system providing a user with real-time price inquiry and price negotiation, which examines a consumer identity, a purchase record, a purchase quantity, a product category and so on and accordingly provides various recommended prices and purchase ways through a computer program and a database to facilitate a purchase transaction. According to the method, when a product has been selected, a user may choose one of a plurality of price negotiation modes (based on quantity, bundle, credit or direct quote) and initiate the price negotiation. Thereafter, the user may decide to complete or abandon the deal, and the price record is collected and saved in the database, serving as an immediate price for next purchase or as a future offer to the customer when the cost is met.

### BACKGROUND OF THE INVENTION

1. Field of the Invention

The present invention relates to a purchase method with price negotiation, and particularly, to a method for a user to perform a purchase transaction with price negotiation through direct interaction with a computer.

2. Description of the Related Art

Nowadays, Internet merchandise is mostly promoted by advertisement though websites established by commercial firms (such as a travel agency), portal sites (such as Kimo, Yahoo and Yam) or other websites to attract Internet customers to purchase products by placing orders via the Internet. In this way, an interaction is directly formed between a commercial firm and a customer through the Internet without a broker who exploits the interests of the commercial firm and the customer.

In the above manner, transactions may be made between commercial firms and customers through direct interaction via the Internet. However, most products are sold via the Internet at a uniform price (a fixed price) or at a discount price, which provides no space for price negotiation, so that Internet commerce is not as prosperous as expected by the commercial firms.

Also, human price negotiations have been adopted in Internet commerce to provide a space for price negotiation, but human price negotiations are performed by human labor or in an off-line manner. Moreover, promotion events are often held to facilitate Internet commerce where different products are bundled together for sale and the prices are specified in advance. However, all these methods fail to achieve a direct interaction with a computer to complete a purchase transaction with a price negotiation.

Therefore, a bid mechanism has been proposed, for example, in R.O.C. Patent Publication No. 486655, by a developer for commercial firms and customers to hold price negotiations through an open architecture platform. According to this patent, on a platform of each bid area, a supplier may present a product and set its quantity-stepped prices. Through major websites and an alliance, this platform is then provided to various alliance websites to attract Internet consumers to perform a group price negotiation on the quantity-stepped prices. Meanwhile, other commercial firms may also bid lower quantity-stepped prices in each bid area through a bid interface for commercial firms. When the bid time is over, the commercial firm who offers the lowest price wins the bid and thus all the Internet customers involved in the group price negotiation are allowed to buy the product at the lowest price.

As described above, the patent provides a platform for the commercial firms and the customers to bid and negotiate on the price of a product, so that the customers may purchase the desired product at a lower price. However, in this process the prices need to be transparent and no space for price negotiation exists, which is less interesting.

In addition, an auction method has been proposed, allowing multiple buyers and one seller to perform a transaction through computers. According to the method, the buyer who bids the highest price wins the bid. However, this is not a method for a buyer to interact directly with a computer to complete a purchase transaction with price negotiation.

Therefore, there is a need to develop a mechanism with a transaction platform having real-time price inquiry and price negotiation functions to improve the interest and to enhance the interaction between a user and a computer, i.e., a purchase transaction with a price negotiation performed through a direct interaction between a user and a computer.

### SUMMARY OF THE INVENTION

The object of the present invention is to provide a system that provides a user with real-time price inquiry and price negotiation to facilitate a purchase transaction. The system includes, but is not limited to, an on-line transaction platform, a single machine, an open system and a closed system.

Another object of the present invention is to provide a system that provides real-time price inquiry and price negotiation to facilitate a purchase transaction. The system examines a user identity, a purchase record, a purchase quantity, a product category and so on, and accordingly offers a variety of possible prices and purchase suggestions to facilitate thereby a real-time purchase transaction.

A further object of the present invention is to provide an Internet on-line purchase method with price negotiation to achieve an interaction between a user and a transaction platform. That is, the invention provides an interactive price negotiation process, by which a user may choose from various price negotiation modes, suggested prices and products directly provided by a computer.

To achieve the above objects, according to the present invention, the method for facilitating a real-time purchase transaction in a system providing a user with real-time price inquiry and price negotiation to facilitate a purchase transaction through a computer program and a database comprises the steps of:
accumulating price negotiation points;
selecting a product to buy;
choosing a price negotiation mode from a mode of negotiating a price based on a quantity, a mode of negotiating a price based on a bundle recommendation, a mode of negotiating a price based on user credit and a mode of negotiating a price based on an immediately quoted purchase price;
after choosing the mode, deducting predetermined points and initiating the price negotiation; and
deciding to reach or to abandon a deal after the price negotiation is completed.

In the step of deciding to reach or to abandon a deal after the price negotiation is complete, if deciding to reach a deal, the product is then added to a shopping cart and a price record of the price negotiation is collected and saved in the database for use as an immediate price for the next purchase.

In the step of deciding to reach or to abandon a deal after the price negotiation is complete, if deciding to abandon a deal, a price record of the price negotiation is then collected and saved in the database so that the price will be offered to the user in the future when the cost is met or a price negotiation will be made directly with a supplier based on the price record of the price negotiation.

### BRIEF DESCRIPTION OF THE DRAWINGS

Features and advantages of the present invention will be more fully understood from the detailed description to follow taken in conjunction with the embodiments as illustrated in the accompanying drawings, which are to be considered in all respects as illustrative and not restrictive, wherein:

FIG. 1 schematically shows the environment for performing the method of the present invention;

FIG. 2 is a flowchart of the operations according to the present invention;

FIG. 3 is a flowchart for explaining the mode of negotiating a price based on a quantity according to the present invention;

FIG. 4 is a flowchart for explaining the mode of negotiating a price based on a bundle recommendation according to the present invention;

FIG. 5 is a flowchart for explaining the mode of negotiating a price based on user credit according to the present invention; and

FIG. 6 is a flowchart for explaining the mode of negotiating a price based on an immediately quoted purchase price according to the present invention.

### DETAILED DESCRIPTION OF PREFERRED EMBODIMENTS

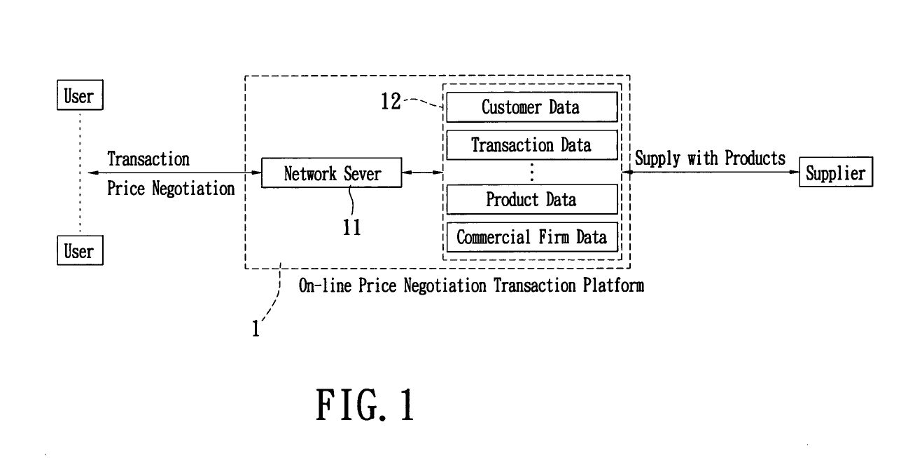

Referring to FIG. 1, an environment for carrying out the method of the present invention is schematically illustrated. For a user (consumer) to perform directly a purchase transaction with interacting price negotiation, through an on-line price negotiation transaction platform 1, the on-line price negotiation transaction platform 1 comprises a network server 11 and a database 12 for storing data including customer data, transaction data, product data and commercial firm data, for example. In order to provide a user with a variety of choices, various price negotiation modes are provided in the on-line price negotiation transaction platform 1. Therefore, on-line price negotiation transaction platform 1 may examine information including a consumer identity a purchase record, a purchase quantity and a product category, for example, through a computer program and the database 12, and accordingly provide a user with a variety of possible prices and purchase suggestions to facilitate thereby a real-time purchase transaction.

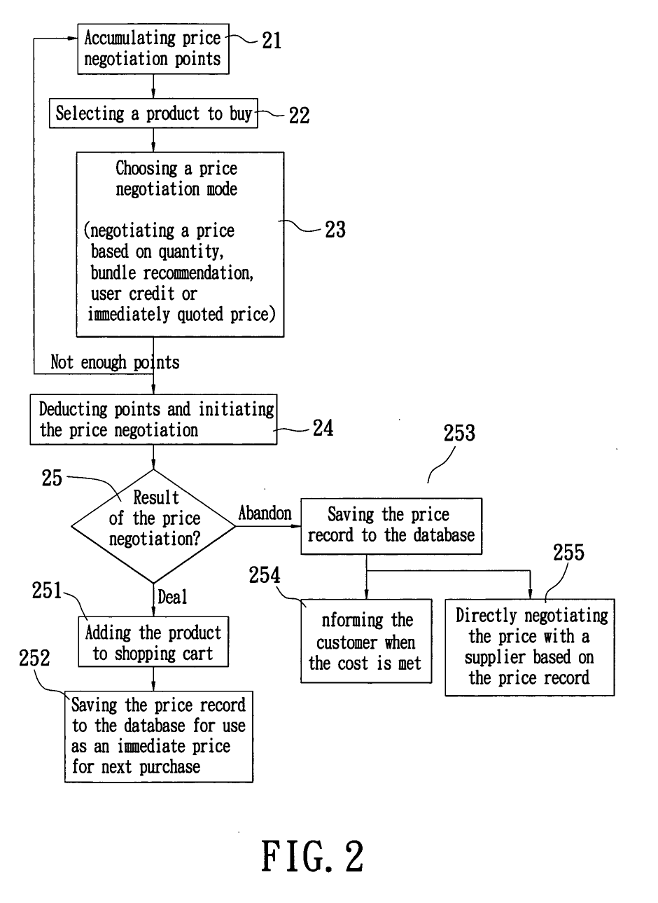

Reference is made to FIG. 2, which shows a flowchart of the operations according to the present invention. The operations include the following steps:

Step 21: accumulating price negotiation points. The price negotiation points are accumulated on the basis of an accumulated transaction amount of on-line purchases and the accumulation rules may vary depending on different price negotiation modes. The price negotiation points may be gained through purchasing a product or by participating in a special event.

Step 22: selecting a product to buy. The products are supplied by suppliers to the database of the transaction platform. All information relating to the product is shown on the transaction platform.

Step 23: choosing from a variety of price negotiation modes, which, according to the embodiment of the present invention, includes four different modes: a mode of negotiating a price based on a quantity, a mode of negotiating a price based on a bundle recommendation, a mode of negotiating a price based on user credit and a mode of negotiating a price based on an immediately quoted purchase price. The price negotiation mode may be chosen by a user or suggested directly by a computer.

Step 24: deducting points and initiating the price negotiation. Predetermined points, e.g., 50 points, are deducted for each price negotiation. If the points are insufficient, the operation goes back to the step of accumulating price negotiation points.

Step 25: determining the result of the price negotiation after the price negotiation is completed. If deciding to reach a deal, the product is added to a shopping cart 251, and a price record of the price negotiation is collected and saved in the database for use as an immediate price for next purchase 252; if deciding to abandon a deal, the price record of the price negotiation is collected and saved in the database 253 so that the price will be offered to the user in the future when the cost is met 254 or that a price negotiation will be made directly with a supplier based on the price record of the price negotiation 255.

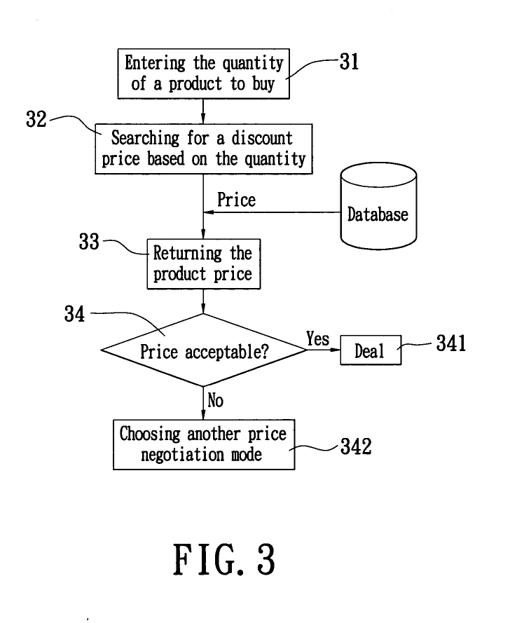

Reference is made to FIG. 3, which shows a flowchart for explaining the mode of negotiating a price based on a quantity according to the present invention. According to the mode of negotiating a price based on a quantity, various discount prices are offered depending on a purchase quantity of a certain product. This price negotiation mode includes the following steps.

Step 31: entering the quantity of a product to be bought.

Step 32: searching for a discount price, which varies depending on the quantity of the product to be bought.

Step 33: returning the product price from the database.

Step 34: determining whether or not the price is acceptable. If the price is acceptable, reaching a deal 341; otherwise, choosing another price negotiation mode 342.

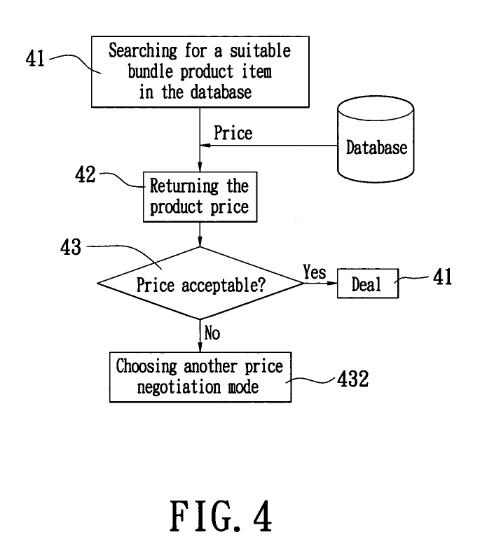

Reference is made to FIG. 4, which shows a flowchart for explaining the mode of negotiating a price based on a bundle recommendation according to the present invention. According to the mode of negotiating a price based on a bundle recommendation, another product is recommended when selecting a certain product and a discount price is offered if both products are purchased. This price negotiation mode includes the following steps:

Step 41: searching for a suitable bundle product item in the database.

Step 42: reporting the product price from the database.

Step 43: determining whether or not the price is acceptable. If the price is acceptable, reaching a deal 431; otherwise, choosing another price negotiation mode 432.

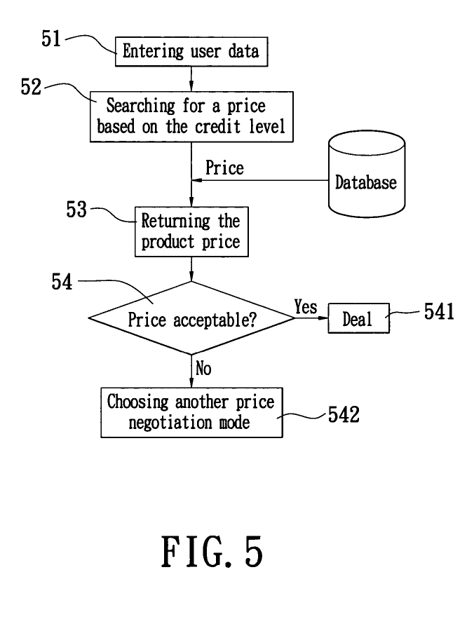

Reference is made to FIG. 5, which shows a flowchart explaining the mode of negotiating a price based on user credit according to the present invention. According to the mode of negotiating a price based on user credit, a credit level is given to a user according to total transaction times and an accumulated transaction amount and various discount prices are offered depending on the credit level. This price negotiation mode includes the following steps:

Step 51: entering user data.

Step 52: searching for a price based on the credit level.

Step 53: reporting the product price from the database.

Step 54: determining whether or not the price is acceptable. If the price is acceptable, reaching a deal 541; otherwise, choosing another price negotiation mode 542.

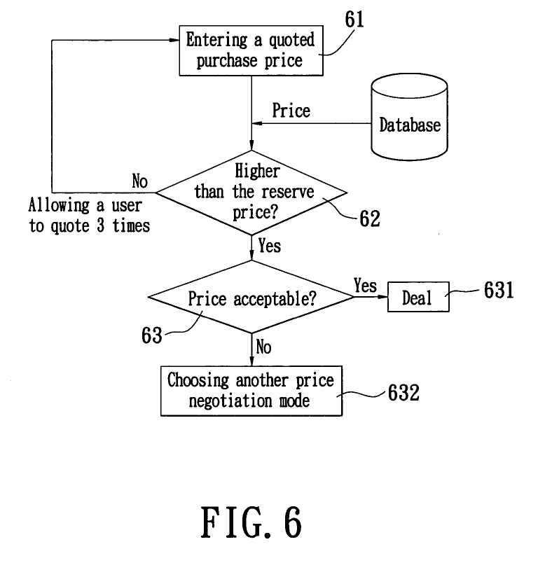

Reference is made to FIG. 6, which shows a flowchart explaining the mode of negotiating a price based on an immediately quoted purchase price according to the present invention. According to the mode of negotiating a price based on an immediately quoted purchase price, a user may quote three or a given number of different purchase prices for a product and the product is sold at the quoted purchase price closest to but not lower than a reserve price set for the product. This price negotiation mode includes the following steps:

Step 61: entering a quoted purchase price.

Step 62: determining whether or not the quoted purchase price is higher than the reserve price (allowing a user to quote three or a given number of different purchase prices). If the quoted purchase price is higher than the reserve price, proceeding to the next step 63; otherwise, returning to the step 61.

Step 63: determining whether or not the price is acceptable. If the price is acceptable, reaching a deal 631; otherwise, abandoning purchase of the product 632.

As can be seen from the above description of the price negotiation mechanism, when the price negotiation points have been accumulated and the purchase product has been selected, the user may choose any one of the price negotiation modes and initiate the price negotiation with a deduction of points. After the price negotiation is completed, the deal or abandoned price is collected and saved in the database 12 of the transaction platform.

Also, in the method of the present invention, the price record may be stored after a price negotiation failure so that the price can be offered to the customer in the future when the cost is met.

Moreover, in addition to a network environment, the method of the present invention may also be carried out in the environment of a single machine, an open system or a closed system.

In summary, the present invention provides a method for a user to perform a purchase transaction with price negotiation through direct interaction with a computer; meanwhile, in the price negotiation process a user may choose from various price negotiation modes or choose the suggested prices or sales contents directly provided by a computer. Hence, the object, scheme and effect of the present invention are very different from the features of the prior arts (such as fixed price, human price negotiation, promotion events, auction and group price negotiation), which is a breakthrough technique of a purchase method with price negotiation.

While the present invention has been described with reference to the detailed description and the drawings of the preferred embodiment thereof, it is to be understood that the invention should not be considered as limited thereby. Various modifications and changes could be conceived of by those skilled in the art without departuring from the scope of the present invention, which is indicated by the appended claims.

1. A purchase method with price negotiation for facilitating a real-time purchase transaction in a system providing a user with real-time price inquiry and price negotiation to facilitate a purchase transaction through a computer program and a database, said method comprising the steps of:
selecting a product to buy;
choosing a price negotiation mode;
initiating the price negotiation; and
deciding to reach or to abandon a deal after the price negotiation is completed.

2. The purchase method with price negotiation of claim 1, wherein the purchase method is carried out in an Internet on-line transaction platform, a single machine, an open system or a closed system.

3. The purchase method with price negotiation of claim 1, wherein the step of choosing a price negotiation mode is conducted based on a user selection or a suggested price directly provided by a computer.

4. The purchase method with price negotiation of claim 1, the price negotiation mode being a mode of negotiating a price based on a quantity, wherein various discount prices are offered depending on a purchase quantity of a certain product, the price negotiation mode comprising the steps of:
entering a quantity of a product to buy;
searching for a discount price based on the quantity;
returning a product price from the database;
determining whether or not the product price is acceptable; and
reaching a deal if the product price is acceptable, or abandoning the deal and choosing another price negotiation mode if the product price is not acceptable.

5. The purchase method with price negotiation of claim 1, the price negotiation mode being a mode of negotiating a price based on a bundle recommendation, wherein another product is recommended when selecting a certain product and a discount price is offered if both products are purchased, the price negotiation mode comprising the steps of:
searching for a suitable bundle product item in the database;
reporting a product price from the database;
determining whether or not the product price is acceptable; and
reaching a deal if the product price is acceptable, or abandoning the deal and choosing another price negotiation mode if the product price is not acceptable.

6. The purchase method with price negotiation of claim 1, the price negotiation mode being a mode of negotiating a price based on user credit, wherein a credit level is given to a user according to total transaction times and an accumulated transaction amount and various discount prices are offered depending on the credit level, the price negotiation mode comprising the steps of:
entering user data;
searching for a product price based on the credit level;
reporting the product price from the database;
determining whether or not the product price is acceptable; and
reaching a deal if the product price is acceptable, or abandoning the deal and choosing another price negotiation mode if the product price is not acceptable.

7. The purchase method with price negotiation of claim 1, the price negotiation mode being a mode of negotiating a price based on an immediately quoted purchase price, wherein a user quotes a given number of different purchase prices for a product and the product is sold at a quoted purchase price closest to but not lower than a reserve price set for the product, the price negotiation mode comprising the steps of:
entering a quoted purchase price;
determining whether or not the quoted purchase price is higher than the reserve price, and allowing a user to quote the given number of different purchase prices;
returning to the step of entering a quoted purchase price if the quoted purchase price is lower than the reserve price;
determining whether or not the quoted purchase price is acceptable if the quoted purchase price is higher than the reserve price; and
reaching a deal if the quoted purchase price is acceptable, or abandoning purchase of the product if the quoted purchase price is not acceptable.

8. The purchase method with price negotiation of claim 1, wherein, in the step of deciding to reach or to abandon a deal after the price negotiation is complete, if deciding to reach a deal, the product is added to a shopping cart and a price record of the price negotiation is collected and saved in the database for use as an immediate price for next purchase.

9. The purchase method with price negotiation of claim 1, wherein, in the step of deciding to reach or to abandon a deal after the price negotiation is complete, if deciding to abandon a deal, then a price record of the price negotiation is collected and saved in the database so that the price will be offered to a user in the future when the price is met or a price negotiation will be made directly with a supplier based on the price record of the price negotiation.

10. The purchase method with price negotiation of claim 1, further comprising accumulating price negotiation points prior to selecting a product to buy.

11. The purchase method with price negotiation of claim 10, wherein the price negotiation points are accumulated on the basis of an accumulated transaction amount of on-line purchases and may be gained by purchasing a product or by participating in a special event.

12. The purchase method with price negotiation of claim 1, wherein, in the step of choosing a price negotiation mode, predetermined points are deducted for each price negotiation of a product, and the method returns to the step of accumulating price negotiation points if the points are insufficient.
